(19) United States
(12) Patent Application Publication
(10) Pub. No.: US 2015/0076025 A1
(43) Pub. Date: Mar. 19, 2015

(54) PACKAGES FOR CONSUMABLE PRODUCTS AND METHODS FOR USING SAME

(71) Applicants: Kimberly Ann Wilmers, Twin Lake, MI (US); Clara Eleanor Grainne O'Connor, Helsingborg (SE); Stephen Andrew Wurth, St. Lous, MO (US); Bethanie Lynn Gasperson, Litchfield, IL (US); Ki Sun Kim, St. Louis, MO (US); Thomas Joseph James, Franklin Lakes, NJ (US)

(72) Inventors: Kimberly Ann Wilmers, Twin Lake, MI (US); Clara Eleanor Grainne O'Connor, Helsingborg (SE); Stephen Andrew Wurth, St. Lous, MO (US); Bethanie Lynn Gasperson, Litchfield, IL (US); Ki Sun Kim, St. Louis, MO (US); Thomas Joseph James, Franklin Lakes, NJ (US)

(73) Assignee: NESTEC S.A., Vevey (CH)

(21) Appl. No.: 14/131,867

(22) PCT Filed: Jul. 10, 2012
(86) PCT No.: PCT/US2012/046029

§ 371 Date: Nov. 25, 2014

Related U.S. Application Data
(60) Provisional application No. 61/507,101, filed on Jul. 12, 2011.

(51) Int. Cl. B65D 1/26; G09F 3/02; B65D 85/60; B65D 25/20; B65D 81/36

(52) U.S. Cl. CPC B65D 1/26; B65D 25/205; B65D 81/36; B65D 85/60; G09F 3/02; G09F 2003/0272
USPC 206/459.5; 220/608; 220/796

(57) ABSTRACT

In a general embodiment, the packages of the present disclosure include a body having a surface defining a recessed portion having a shape, and a lid having a surface defining a projection having a shape and a size that corresponds to the shape and size of the recessed portion. The packages include a color that corresponds to a type of the consumable product.

### BACKGROUND

The present disclosure relates generally to packaging. More specifically, the present disclosure relates to containers for storing consumable products and methods of using same.

Packaging for consumable products come in a variety of sizes, shapes, materials and designs. These sizes, shapes, materials and designs generally differ, for example, for aesthetic reasons. Although consumable product packaging may be provided to enhance aesthetic qualities of packages, the purposes for consumable product packaging are not limited to only this purpose.

Indeed, consumable product packages aimed at providing improved aesthetic qualities of a package may not always provide optimal functionality or use, and may not sufficiently aid consumers in differentiating one product from another. Instead, consumable product packaging having specific shapes, sizes and/or colors may provide functional advantages to a consumer and/or user of such packages in addition to possible aesthetic advantages.

### SUMMARY

The present disclosure is related to packages for housing consumable products. The packages may be customized, contemporary packages that provide easy handling of the packages by a toddler or caregiver during feeding, novel ways in which to convey nutritional information, multiple uses for the packages, and increase purchase interest and marketability amongst consumers.

In an embodiment, the packages of the present disclosure provide a package having a body and a lid. The body defines an interior configured to house a consumable product and having a bottom surface defining a recessed portion having a shape, and the a lid includes a surface defining a projection having a shape and a size that corresponds to a shape and size of the recessed portion on the body, and a color that corresponds to a type of the consumable product housed by the body.

In an embodiment, the recessed portion of the body and the projection of the lid have a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, or combinations thereof.

In an embodiment, the projection of the lid is sized slightly smaller than the recessed portion of the body such that the projection of the lid may be inserted into the recessed portion of the body.

In an embodiment, the color of the lid is different for packages housing a protein, a vegetable, a grain, and a fruit. For example, the color of the lid may be green when the consumable product housed by the body is a vegetable, or red when the consumable product housed by the body is a fruit, or yellow when the consumable product housed by the body is a grain, or orange when the consumable product housed by the body is a protein.

In an embodiment, the body further comprises a gripping portion. The gripping portion may be dimple grips and may have a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, or combinations thereof. The gripping portion may cover from about 5% to about 100% of a circumference of the body, or from about 10% to about 90% of a circumference of the body, or from about 20% to about 80% of a circumference of the body, or from about 30% to about 70% of a circumference of the body, or from about 40% to about 60% of a circumference of the body or about 50% of a circumference of the body. The body may also include a plurality of gripping portions.

In an embodiment, the lid further includes a childlike indicia. The childlike indicia may be placed on the lid by a method selected from the group consisting of embossing, debossing, printing, engraving, a sticker, or combinations thereof. In an embodiment, the childlike indicia is a smiley face.

In an embodiment, the body has a shape selected from the group consisting of a cylinder, a cube, a cuboid, a pyramid, a cone, a prism, or combinations thereof. The lid may have a rounded shape.

In an embodiment, the body comprises an indicia. The indicia may be placed on the body by a method selected from the group consisting of embossing, debossing, printing, engraving, a sticker, or combinations thereof. In an embodiment, the indicia is placed on the body by a sticker.

In an embodiment, the indicia includes an image that corresponds to a type of consumable product housed by the body. The image may be selected from the group consisting of a vegetable, a fruit, a grain, a protein, or combinations thereof. The indicia may be nutritional information, a color that corresponds to a type of consumable product housed by the body, a number that corresponds to a type of consumable product housed by the body, a letter that corresponds to a type of consumable product housed by the body, etc.

In an embodiment, the package is configured to easily convey product information to a consumer. The package may also be configured to aid in providing a balanced meal to a toddler, or may be configured for multiple uses. The multiple uses may include at least use as a feeding device and use as a toy.

In an embodiment, the lid includes a tab extending in a direction that is substantially perpendicular to a portion of the lid that covers the body. The tab may also extend in a direction that is substantially parallel to a side wall of the body.

In another embodiment, a consumable product package kit is provided and includes a package and a feeding pad. The package includes a body defining an interior configured to house a consumable product and comprising a bottom surface defining a recessed portion having a shape, and a lid having a surface defining a projection having a shape and a size that corresponds to a shape and size of the recessed portion on the body, and a color that corresponds to a type of the consumable product housed by the body. The feeding pad includes a substantially flat surface having at least one projection having a shape and a size that corresponds to a shape and size of the recessed portion of the body.

In an embodiment, the projection of the feeding pad has a shape selected from the group consisting of a circle, square, rectangle, triangle, quadrilateral,

In an embodiment, the feeding pad comprises a plurality of projections. Each of the plurality of projections may have a different shape and a different color. The shapes and colors may correspond to a type of consumable product housed by the body of the package. In an embodiment, the feeding pad comprises at least two different shaped projections.

In an embodiment, a recessed portion of the body and a projection of the lid have a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, or combinations thereof.

In an embodiment, the projection of the lid is sized slightly smaller than the recessed portion of the body such that the projection of the lid may be inserted into the recessed portion of the body.

In an embodiment, the color of the lid is different for packages housing a protein, a vegetable, a grain, and a fruit. For example, the color of the lid may be green when the consumable product housed by the body is a vegetable, or red when the consumable product housed by the body is a fruit, or yellow when the consumable product housed by the body is a grain, or orange when the consumable product housed by the body is a protein.

In an embodiment, the body further comprises a gripping portion. The gripping portion may be dimple grips and may have a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, or combinations thereof. The gripping portion may cover from about 5% to about 100% of a circumference of the body, or from about 10% to about 90% of a circumference of the body, or from about 20% to about 80% of a circumference of the body, or from about 30% to about 70% of a circumference of the body, or from about 40% to about 60% of a circumference of the body or about 50% of a circumference of the body. The body may also include a plurality of gripping portions.

In an embodiment, the lid further includes a childlike indicia. The childlike indicia may be placed on the lid by a method selected from the group consisting of embossing, debossing, printing, engraving, a sticker, or combinations thereof. In an embodiment, the childlike indicia is a smiley face.

In an embodiment, the body comprises an indicia. The indicia may be placed on the body by a method selected from the group consisting of embossing, debossing, printing, engraving, a sticker, or combinations thereof. In an embodiment, the indicia is placed on the body by a sticker.

In an embodiment, the indicia includes an image that corresponds to a type of consumable product housed by the body. The image may be selected from the group consisting of a vegetable, a fruit, a grain, a protein, or combinations thereof. The indicia may be nutritional information, a color that corresponds to a type of consumable product housed by the body, a number that corresponds to a type of consumable product housed by the body, a letter that corresponds to a type of consumable product housed by the body, etc.

In an embodiment, the package is configured to easily convey product information to a consumer. The package may also be configured to aid in providing a balanced meal to a toddler, or may be configured for multiple uses. The multiple uses may include at least use as a feeding device and use as a toy.

In an embodiment, the lid includes a tab extending in a direction that is substantially perpendicular to a portion of the lid that covers the body. The tab may also extend in a direction that is substantially parallel to a side wall of the body.

In yet another embodiment, a consumable product package is provided and includes a container for housing consumable products and a sleeve configured to surround at least a portion of the container. The container has a color that corresponds to a type of the consumable product housed by the container, and the sleeve has at least four sides, each of the four sides comprising an indicia.

In an embodiment, the container comprises a body and lid. The body and the lid may be the same color or a different color. In an embodiment, a color of the body or lid is different for packages housing a protein, a vegetable, a grain, and a fruit. For example, the color of the body/lid may be green when the consumable product housed by the body is a vegetable, or red when the consumable product housed by the body is a fruit, or yellow when the consumable product housed by the body is a grain, or orange when the consumable product housed by the body is a protein.

In an embodiment, the container has a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, or combinations thereof. The container may have a visible indicia thereon.

In an embodiment, the sleeve comprises a shape that is a square. The sleeve may also have a visible indicia thereon. The indicia may be placed on the sleeve by a method selected from the group consisting of embossing, debossing, printing, engraving, a sticker, or combinations thereof. The indicia may be placed on the sleeve by printing.

In an embodiment, each side of the sleeve comprises a different indicia selected from the group consisting of a brand logo, nutritional information, an image that corresponds to the consumable product housed by the container, a number that corresponds to the consumable product housed by the container, a letter that corresponds to the consumable product housed by the container, a color that corresponds to the consumable product housed by the container, a legend containing elements for a balanced meal, or combinations thereof.

In an embodiment, a first side of the sleeve comprises an image that corresponds to the consumable product housed by the container, a second side of the sleeve comprises a number that corresponds to the consumable product housed by the container, a third side of the sleeve comprises a color that corresponds to the consumable product housed by the container, and a fourth side of the sleeve comprises a legend containing elements for a balanced meal.

In an embodiment, a color of the container and the indicia of the sleeve both correspond to a type of consumable product housed by the container.

In an embodiment, the image is selected from the group consisting of a vegetable, a fruit, a grain, a protein, or combinations thereof. The indicia may also be nutritional information.

In an embodiment, the package resembles a child's building block.

In an embodiment, the package is configured to easily convey product information to a consumer. The package may also be configured to aid in providing a balanced meal to a toddler, or may be configured for multiple uses. The multiple uses may include at least use as a feeding device and use as a toy.

In still yet another embodiment, a package is provided and includes a body defining at least one compartment for housing a consumable product, first and second projections extending from the body, and a perimeter having a shape that resembles an airplane. The first projection is located in a location that corresponds to a first wing of the airplane-shaped perimeter and the second projection is located in a location that corresponds to a second wing of the airplane-shaped perimeter.

In an embodiment, the interior compartment has a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, or combinations thereof.

In an embodiment, the body further defines a hook at a top portion of the package for receiving a hanger.

In an embodiment, the consumable products are selected from the group consisting of snack foods, side meals, full meals, or combinations thereof.

In an embodiment, at least a portion of the perimeter and a portion of a bottom surface of the compartment form a plane to allow the package to stand substantially upright.

In an embodiment, a first projection of the package is configured to mate with a second projection of a second package. In a similar manner, a second projection of the package may be configured to mate with a first projection of a third package.

In an embodiment, the color of the body is different for packages housing a protein, a vegetable, a grain, and a fruit. For example, the color of the body may be green when the consumable product housed by the body is a vegetable, or red when the consumable product housed by the body is a fruit, or yellow when the consumable product housed by the body is a grain, or orange when the consumable product housed by the body is a protein.

In an embodiment, the body further includes a childlike indicia. The childlike indicia may be placed on the body by a method selected from the group consisting of embossing, debossing, printing, engraving, a sticker, or combinations thereof. In an embodiment, the childlike indicia is a smiley face.

In an embodiment, the package further comprises a sleeve configured to surround at least a portion of the body. The sleeve may have a shape that is substantially rectangular and may have an indicia thereon. The indicia may be placed on the sleeve by a method selected from the group consisting of embossing, debossing, printing, engraving, a sticker, or combinations thereof. In an embodiment, the indicia is placed on the sleeve by printing.

In an embodiment, each side of the sleeve comprises a different indicia selected from the group consisting of a brand logo, nutritional information, an image that corresponds to the consumable product housed by the container, a number that corresponds to the consumable product housed by the container, a letter that corresponds to the consumable product housed by the container, a color that corresponds to the consumable product housed by the container, a legend containing elements for a balanced meal, or combinations thereof.

In an embodiment, a front side of the sleeve comprises an image that corresponds to the consumable product housed by the container, and a back side of the sleeve comprises a color that corresponds to the consumable product housed by the container and nutritional information. In an embodiment, the image is selected from the group consisting of a vegetable, a fruit, a grain, a protein, or combinations thereof.

In an embodiment, a color of the body and the indicia of the sleeve both correspond to a type of consumable product housed by the container.

In an embodiment, the package is configured to easily convey product information to a consumer. The package may also be configured to aid in providing a balanced meal to a toddler, or may be configured for multiple uses. The multiple uses may include at least use as a feeding device and use as a toy.

In another embodiment, a package is provided and includes a body having a first compartment and a second compartment connected by a perforation. The first and second compartments are arranged side by side in a first configuration. The package may also be folded along the perforation such that the first compartment rests on top of the second compartment in a second configuration.

In an embodiment, further comprising a cover sealed to a top side of the package to seal the first and second compartments. The cover may be a material selected from the group consisting of cardboard, paperboard, cardstock, fiberboard, lidstock, or combinations thereof. The cover may also include a perforation or a cut at a location corresponding to the perforation of the body.

In an embodiment, the first and second compartments each have a bottom surface having an embossed or debossed shape. The embossed or debossed shape may be selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, or combinations thereof. The shape may also be indicative of a type of consumable product that is housed by the first or second compartments.

In an embodiment, the first compartment rests upside down on the second compartment in the second configuration.

In an embodiment, the body of the package has a color that is indicative of a consumable product housed by the first and second compartments.

In an embodiment, a color of the body is different for packages housing a protein, a vegetable, a grain, and a fruit. For example, the color of the body may be green when the consumable product housed by the body is a vegetable, or red when the consumable product housed by the body is a fruit, or yellow when the consumable product housed by the body is a grain, or orange when the consumable product housed by the body is a protein.

In an embodiment, the two or more trays will be produced separately and welded together.

In an embodiment, the two or more trays will different tray depths.

In an embodiment, the two or more trays will different diameters and different tray depths.

In an embodiment, the two or more trays will contain different products.

In an embodiment, the two or more trays will contain the same product.

In an embodiment, the two or more trays will contain items that will be used together.

In an embodiment, at least one of the two or more trays will contain items that will be used together.

In an embodiment, the two or more trays will contain items for different parts of the meal.

In an embodiment, the two or more trays will contain items that require different processing.

In an embodiment, the two or more trays are perforated by laser cutting.

In an embodiment, the two or more trays are perforated and the lid stock is cut by laser cutting.

In an embodiment, the two or more trays are perforated after being heat treated. In an embodiment the heat treating is retort processing.

In an embodiment, the two or more trays are separated after being heat treated. In an embodiment the heat treating is retort processing.

In an embodiment, the two or more trays can contain two or more of the meals for the day. For example, one tray can contain breakfast, one tray can contain lunch, one tray can contain a snack, and/or one tray can contain dinner.

In yet another embodiment, a method for providing a child with a balanced meal is provided. The method includes providing at least two different packages, each package comprising (i) a body comprising a surface defining a recessed portion having a shape, the body being configured to house a consumable product and (ii) a lid comprising a surface defining a projection having a shape and a size that corresponds to the shape and size of the recessed portion, and a color that corresponds to a type of the consumable product. The method further includes serving the child a meal comprising at least one of each of the different packages.

In still yet another embodiment, a method for providing a child with a balanced meal is provided. The method includes providing at least two different packages, each package comprising (i) a body comprising a surface defining a recessed portion having a shape, the body being configured to house a consumable product, and (ii) a lid comprising a surface defining a projection having a shape and a size that corresponds to the shape and size of the recessed portion, and a color that is indicative of a type of the consumable product. The method further includes providing a feeding pad comprising a substantially flat surface having at least one projection having a shape and a size that corresponds to the shape and size of the recessed portion of the body, matching the shape of the recessed portion of the body with at least one of the projections of the feeding pad, and placing the package on the feeding pad by mating the matched recessed portion of the body with the matching at least one projection of the feeding pad.

In another embodiment, a method for providing a child with a balanced meal is provided. The method includes providing at least two different packages, each package comprising (i) a container for housing a consumable product, the container having a color that corresponds to a type of the consumable product housed by the container, and (ii) a sleeve configured to house the container, the sleeve having at least four sides, each of the four sides comprising an indicia. The method further includes serving the child a meal comprising at least one of each of the different packages.

In yet another embodiment, a method for providing a child with a balanced meal is provided. The method includes providing at least two different packages, each package comprising a body defining at least one interior compartment for housing a consumable product, first and second projections extending from the body, and a perimeter having a shape that resembles an airplane, wherein the first projection is located in a location that corresponds to a first wing of the airplane-shaped perimeter and the second projection is located in a location that corresponds to a second wing of the airplane-shaped perimeter. The method further includes attaching a first projection of a first package to a second projection of the second package, and serving the child a meal comprising the attached first and second packages.

In still yet another embodiment, a method for marketing consumable products is provided. The method includes providing a package comprising (i) a body comprising a surface defining a recessed portion having a shape, the body being configured to house a consumable product and (ii) a lid comprising a surface defining a projection having a shape and a size that corresponds to the shape and size of the recessed portion, and a color that corresponds to a type of the consumable product. The method further includes placing the package on a retail shelf.

In another embodiment, a method for marketing consumable products is provided. The method includes providing a consumable product package kit comprising (i) a body comprising a surface defining a recessed portion having a shape, the body being configured to house a consumable product, (ii) a lid comprising a surface defining a projection having a shape and a size that corresponds to the shape and size of the recessed portion, and a color that is indicative of a type of the consumable product, and (iii) a feeding pad comprising a substantially flat surface having at least one projection having a shape and a size that corresponds to the shape and size of the recessed portion of the body. The method further includes placing the consumable product package kit on a retail shelf.

In yet another embodiment, a method for marketing consumable products is provided. The method includes providing a package comprising (i) a container for housing a consumable product, the container having a color that corresponds to a type of the consumable product housed by the container, and (ii) a sleeve configured to house the container, the sleeve having at least four sides, each of the four sides comprising an indicia. The method further includes placing the consumable product package kit on a retail shelf.

In still yet another embodiment, a method for marketing consumable products is provided. The method includes providing a package comprising a body defining at least one interior compartment for housing a consumable product, first and second projections extending from the body, and a perimeter having a shape that resembles an airplane, wherein the first projection is located in a location that corresponds to a first wing of the airplane-shaped perimeter and the second projection is located in a location that corresponds to a second wing of the airplane-shaped perimeter. The method further includes placing the consumable product package kit on a retail shelf.

It is an advantage of the present disclosure to provide improved consumable product containers.

It is also an advantage of the present disclosure to provide consumable product containers that are aesthetically pleasing to children.

It is another advantage of the present disclosure to provide consumable product containers that teach children about matching shapes.

It is yet another advantage of the present disclosure to provide consumable product containers that improve shape, color and size identification by children.

It is still yet another advantage of the present disclosure to provide consumable product containers that improve the dexterity of children.

It is another advantage of the present disclosure to provide consumable product containers that improve marketability of the containers.

It is a further advantage of the present disclosure to provide consumable product containers that are easily gripped by caretakers and/or toddlers for handling of children's foods.

Yet another advantage of the present disclosure is to provide consumable product containers that are easily gripped by children for self-feeding.

It is another advantage of the present disclosure to provide consumable product containers that multifunctional and may be used for feeding and/or playing.

Additional features and advantages are described herein, and will be apparent from the following Detailed Description and the figures.

### BRIEF DESCRIPTION OF THE FIGURES

FIG. 1 is a perspective view of a consumable product container in accordance with an embodiment of the present disclosure.

FIG. 2 is a side view of a consumable product container in accordance with an embodiment of the present disclosure.

FIG. 3 is a side view of stacked consumable product containers in accordance with an embodiment of the present disclosure.

FIG. 4 is a perspective view of a consumable product container in accordance with an embodiment of the present disclosure.

FIG. 5 is a side view of stacked consumable product containers in accordance with an embodiment of the present disclosure.

FIG. 6 is a perspective view of a feeding pad for use with consumable product containers in accordance with an embodiment of the present disclosure.

FIG. 7 is a perspective view of a feeding pad and consumable product containers in accordance with an embodiment of the present disclosure.

FIG. 8 is a perspective view of a consumable product container in accordance with an embodiment of the present disclosure.

FIG. 9 is a perspective view of a consumable product container in accordance with an embodiment of the present disclosure.

FIG. 10A illustrates a side panel of a consumable product container in accordance with an embodiment of the present disclosure.

FIG. 10B illustrates a side panel of a consumable product container in accordance with an embodiment of the present disclosure.

FIG. 10C illustrates a side panel of a consumable product container in accordance with an embodiment of the present disclosure.

FIG. 10D illustrates a side panel of a consumable product container in accordance with an embodiment of the present disclosure.

FIG. 11 is a perspective view of a consumable product container in accordance with an embodiment of the present disclosure.

FIG. 12 is a perspective view of a consumable product container in accordance with an embodiment of the present disclosure.

FIG. 13 is a top view of multiple connected consumable product containers in accordance with an embodiment of the present disclosure.

FIG. 14 is a perspective view of a consumable product container in accordance with an embodiment of the present disclosure.

FIG. 15 is a side view of a consumable product container in accordance with an embodiment of the present disclosure.

FIG. 16 is a perspective view of a consumable product container in accordance with an embodiment of the present disclosure.

FIG. 17 is a perspective view of a consumable product container in accordance with an embodiment of the present disclosure.

FIG. 18 is a perspective view of a consumable product container in accordance with an embodiment of the present disclosure.

FIG. 19 is a top view of a consumable product container in accordance with an embodiment of the present disclosure.

FIG. 20 is a side view of a consumable product container in accordance with an embodiment of the present disclosure.

FIG. 21 is a bottom view of a consumable product container in accordance with an embodiment of the present disclosure.

FIG. 22 is a perspective view of two consumable product containers, illustrating how they would connect in accordance with an embodiment of the present disclosure.

FIG. 23 is a perspective view of multiple connected consumable product containers in accordance with an embodiment of the present disclosure.

### DETAILED DESCRIPTION

The present disclosure provides packages for housing consumable products. The packages may be custom designed for ease of use by toddlers and/or their caregivers, and may also be designed to highlight nutritional information in a contemporary manner. In this regard, the packages may use colors, shapes, and other such features to provide easy handling of the packages by a toddler or caregiver during feeding, novel ways in which to convey nutritional information, multiple uses for the packages, and increased purchase interest and marketability amongst consumers.

The consumable products housed by the packages may be any consumable products including, for example, baby foods, snack foods, full meals, side meals, etc. In an embodiment, the packages house foods for children (e.g., infants, toddlers, pre-schoolers, etc.) including, for example, fruits, vegetables, grains, cereals, pastas, etc. The consumable products may be finger foods or may be designed to be consumed using utensils. The teachings of the present disclosure, therefore, are not dependent upon the consumable products being of any particular type so long as the products fit within the package described herein.

The bodies of packages of the present disclosure may be made from a molded plastic material such as, for example, polyethylene, polypropylene, or the like, or combinations thereof. The bodies may be formed using conventional thermoforming or molding processes including, but not limited to, injection molding, injection blow molding and extrusion blow molding. Alternatively, the bodies may be manufactured from non-plastic materials including, but not limited to, cardboard, metal, styrofoam, etc. Further, at least a portion of the bodies can be either transparent or translucent so that a consumer can readily discern what types of products are housed in the compartments of the packages. Alternatively, at least a portion of the bodies may be opaque. In an embodiment wherein a lid is provided, the lid may be manufactured from a same or different material as the body and may be translucent while the body is opaque, or vice versa.

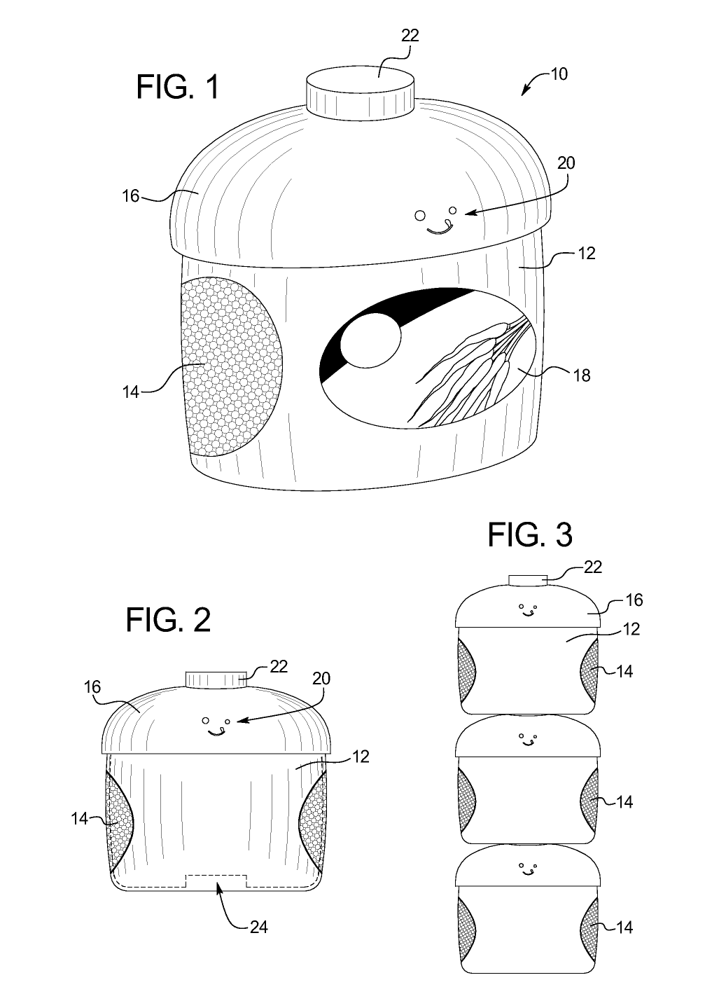

In an embodiment, and as shown in FIG. 1, a package 10 for storing consumable products is provided. Package 10 includes a body 12 that defines an interior compartment (not shown). Although body 12 of package 10 is illustrated as being substantially cylindrical in shape, body 12 of package 10 may define any shape that is known in the art. For example, body 12 may be cylinder, a cube, a cuboid, a pyramid, a cone, a prism, etc., so long as body 12 is capable of housing a consumable product within an interior compartment. For ease of reference, and with this embodiment, body 12 will be discussed as being an oval body 12. Body 12 is also not limited to any particular size so long as consumable products may be contained therein and may be easily handled by a toddler or a caregiver of a toddler. The skilled artisan will appreciate that the dimensions of package 10 may vary as desired or in accordance with manufacturing specifications or in accordance with the size and shape of the consumable products contained therein.

The interior compartment (not illustrated) of body 12, however, should have a size and shaped that allows a toddler to easily self-feed. For example, the interior compartment may have a circular or oval shape that will allow a toddler to reach into body 12 to remove consumable products housed therein to self-feed. Since the dexterity of toddlers is limited or not fine-tuned, a toddler may have a difficult time removing food from body 12 if the interior compartment has corners in which food may become lodged or stuck and require fine motor control to remove. In an embodiment, the interior compartment has a circular shape. In an embodiment, body 12 may include more than one compartment.

To ensure a good grip on body 12 during feeding, body 12 may include a grip portion 14 on at least a portion of body 12, or surrounding body 12, etc. For example, grip portion 14 may cover from about 5% to about 100% of a circumference of body 12, or from about 10% to about 90%, or from about 20% to about 80%, or from about 30% to about 70%, or from about 40% to about 60%. In an embodiment, grip portion 14 covers about 50% of a circumference of body 12. In this manner, there may be at least some of a grip portion 14 all around body 12.

Grip portions 14 may also have any shape known in the art including, for example, circles, squares, rectangles, triangles, numbers, letters, stars, smiley faces, etc. Similarly, there may be any number of grip portions 14 on an outer surface of body 12. In an embodiment, and as shown n FIGS. 1-3, body 12 may have two, circular shaped grip portions 14 located at 180° from each other along the circumference of body 12. The skilled artisan will appreciate that grip portion 14 may have any size and shape known in the art, so long as grip portions 14 aids in handling of package 10 by a toddler or a toddler's caregiver. In an embodiment, dimple grips are used as grip portions 14. Grip portions 14 may be especially useful in embodiments wherein the consumable product housed by package 10 is a finger food that a child can consume without the use of utensils.

Package 10 also includes a lid 16 that is sized and shaped to fit with body 12. Lid 16 is not limited to any particular shape or size, so long as lid 16 is capable of sealingly fitting to body 12 to prevent loss or contamination of a consumable product housed therein. In this manner, lid 16 may be mated with body 12 by snap-fitting, pressure-fitting, friction fitting, etc. Lid 16 may be fitted to body 12 in a resealing manner so that each time lid 16 is removed from body 12, it may be placed on body 12 again in a sealed manner.

Lid 16 may have a color that is indicative of a type of food contained in body 12. For example, if four packages are provided, each having a different color, the color of each package may indicate whether the package contains a protein (e.g., orange), a vegetable (e.g., green), a fruit (e.g., red), or a grain (e.g., yellow). By providing a package having a specific color that represents a specific food type (e.g., proteins, grains, fruits, etc.) the present packages can provide ease of shopping and home inventory for a toddler's caregiver. In this manner, a caregiver can easily provide a balanced meal by providing one serving each, of vegetables, fruits, proteins and grains simply by selecting packages having different colors. The skilled artisan will appreciate, however, that the present disclosure is not limited to the color/food relationships mentioned herein and any color may be used to represent any type of consumable product, so long as the colors and types of foods are used consistently.

Another way in which caregivers can easily piece together a nutritional meal for a toddler, is by providing indicia 18 on body 12 that is indicative of the type of food contained in body 12. For example, body 12 may have indicia 18 thereon that shows a bundle of carrots, which would be indicative of a vegetable (e.g., carrots). In another example, body 12 may have indicia 18 thereon that shows an apple, which would be indicative of a fruit (e.g., apples). Alternatively, indicia 18 may simply be a portion of solid color that represents the same color scheme as discussed above with respect to lid 16. For example, lid 16 may have a color that is the same as body 12, but to indicate the nutritional content of package 10, body 12 may have a colored indicia thereon that is representative of a food group contained therein (e.g., orange for a protein, green for a vegetable, red for a fruit, or yellow for a grain). Indicia 18 may include, for example, colors, numbers, letters, logos, advertisements, branding information, nutritional information, product information, manufacturer information, etc. Indicia 18 may be printed on a pressure sensitive material, printed directly on body 12, printed on a removable closure, attached as a sticker, etc.

To appeal to a toddler, lid 16 may also include an embossed, debossed, printed, or sticker shape 20 that provides a fun, childlike feature to package 10. For example, and as shown in FIGS. 1-3, lid 16 may include an engraved smiley face shape 20 that children may find fun and which may increase the child's desire to self-feed or may make the child excited for meal time.

Lid 16 may further include at least one projection 22 (e.g., a positive shape) on a top portion of lid 16, which is illustrated as having a rounded

[symbol]

Accordingly, a childlike indicia/shape 20 and projections 22 may promote use of package 10 as more than a consumable product package 10, thereby making package 10 multifunctional for feeding and play time purposes. In this manner, the child may be able to play with package 10 as a toy before, during or after meal time. Caregivers may also select a balanced meal for a toddler based on the color scheme discussed above, stack the selected meal packages 10, and serve the meal to a toddler. This presentation makes meal time fun for the toddler, who may be allowed to “play” with packages 10 to unstuck them, open them, self-feed, and then (if desired) play with or restack empty packages 10.

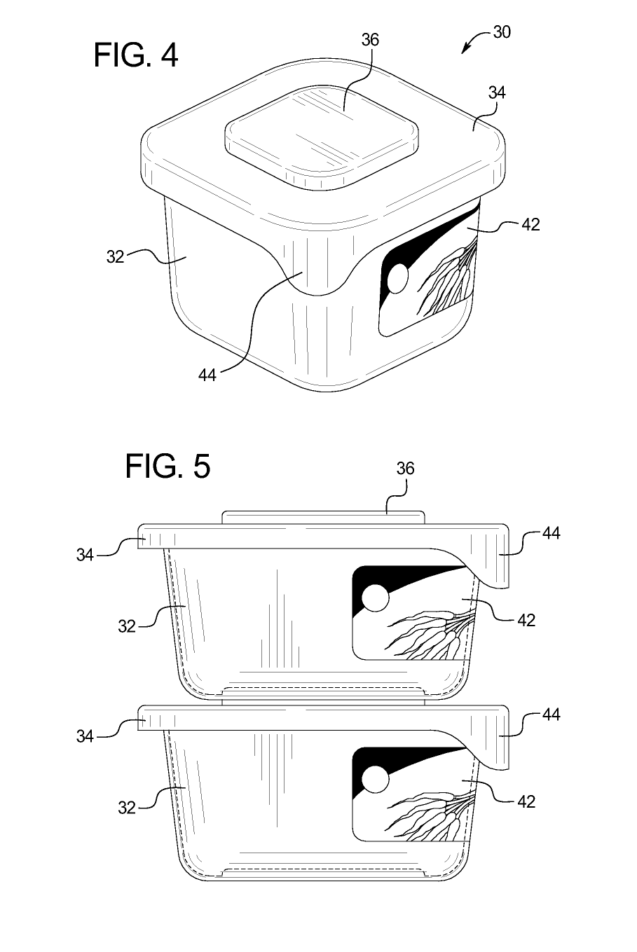

In another embodiment, and as shown in FIGS. 4-7, a package 30 for storing consumable products is provided. Package 30 includes a body 32 that defines an interior compartment (not shown). Although body 32 of package 30 is illustrated as being substantially cylindrical in shape, body 32 of package 30 may define any shape that is known in the art. For example, body 32 may be square, rectangular, oval (e.g., oblong), triangular, etc., so long as body 32 is capable of housing a consumable product within an interior compartment. For ease of reference, and with this embodiment, body 32 will be discussed as being a square body 32. Body 32 is also not limited to any particular size so long as consumable products may be contained therein and may be easily handled by a toddler or a caregiver of a toddler. The skilled artisan will appreciate that the dimensions of package 30 may vary as desired or in accordance with manufacturing specifications or in accordance with the size and shape of the consumable products contained therein.

The interior compartment (not illustrated) of body 32, however, should have a size and shaped that allows a toddler to easily self-feed. For example, the interior compartment may have a circular or oval shape that will allow a toddler to reach into body 32 to remove consumable products housed therein to self-feed. Since the dexterity of toddlers is limited or not fine-tuned, a toddler may have a difficult time removing food from body 32 if the interior compartment has corners in which food may be lodged or stuck and require fine motor control to remove therefrom. In an embodiment, the interior compartment has a square shape with rounded corners. In an embodiment, body 32 may include more than one compartment.

Package 30 also includes a lid 34 that is sized and shaped to fit with body 32. Lid 34 is not limited to any particular shape or size, so long as lid 34 is capable of sealingly fitting to body 32 to prevent loss or contamination of a consumable product housed therein. In this manner, lid 34 may be mated with body 32 by snap-fitting, pressure-fitting, friction fitting, etc. Lid 34 may be fitted to body 32 in a resealing manner so that each time lid 34 is removed from body 32, it may be placed on body 32 again in a sealed manner. In an embodiment, lid 34 is a substantially flat lid, as illustrated in FIGS. 4-5 and 7. However, the skilled artisan will appreciate that lid 34 may have any shape known in the art.

Lid 34 of package 30 may also include a tab 44 extending downward from lid 34 in a direction so that tab 44 extends parallel to a side wall of body 32, and perpendicular to a portion of lid 34 that covers the open interior of body 32. Tab 44 may be located on any side of lid 34, or on any corner of lid 34 and may be used to easily separate lid 34 from body 32. Easy removal of lid 34 from body 32 allows for easier self-feeding by a toddler, and allows a toddler the ability to easily and enjoyable play with package 30 after it has been emptied of its consumable products. In much the same manner, tab 44 also makes it easier for a caregiver to remove lid 34 to feed a toddler during meal time.

Similar to lid 16, lid 34 may include at least one projection 36 (e.g., a positive shape) embossed on a top portion. Projection 36 may have any size and shape known in the art. In an embodiment, however, projection 36 may have a shape easily recognizable to a toddler such as, for example, a circle, a square, a rectangle, a triangle, a star, a flower, etc., and may be sized to mate with a similarly shaped cut-away portion 38 (e.g., a negative shape, not illustrated) of a bottom of body 32. Similar to packages 10, when packages 30 are fully assembled having body 32 and lid 34, a first package 30 may be stacked onto a second package 30, as shown in FIG. 5. When stacked, a projection 36 of a first package 30 will mate with a similarly shaped cut-away portion (not illustrated) of a bottom surface of body 32 of a second package 30. Projection 36 may also have a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, or combinations thereof.

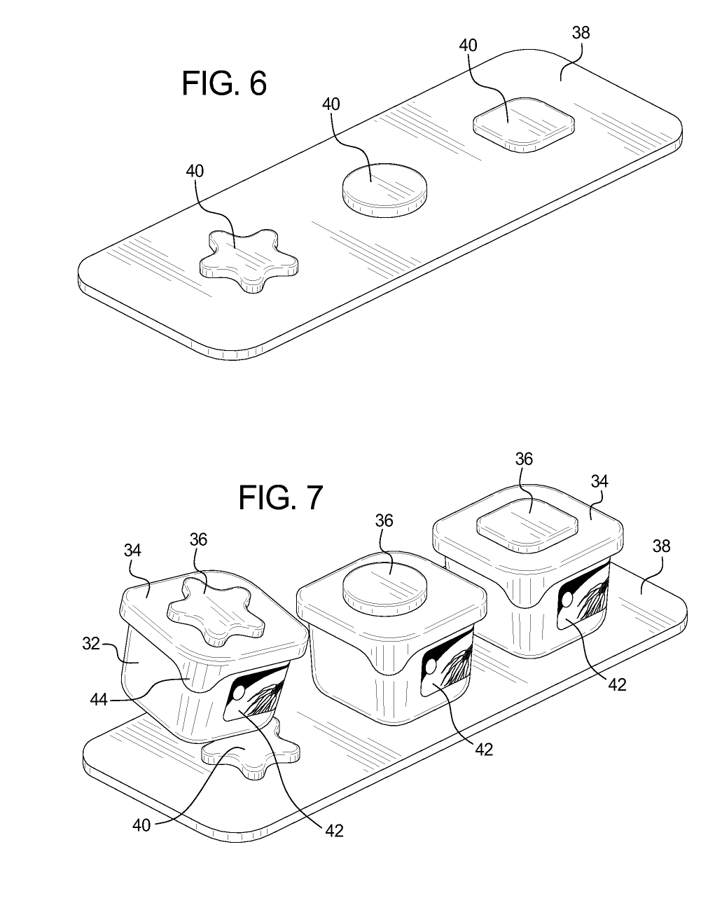

As shown in FIG. 6, a feeding pad 38 may also be provided to a child before, during or after feeding. In this embodiment, instead of simply allowing the child to stack the food containing packages on top of each other, the child may also match a shaped projection 36 on top of package 30, or the shaped recess of a bottom surface of body 32, with a matching shaped projection 40 on feeding pad 38, as shown in FIG. 7. Once matched with the corresponding shapes 40 on feeding pad 38, projected shapes 40 help to keep packages 30 from tipping or spilling during feeding time. Feeding pad 38 may also have a non-skid surface that prevents feeding pad 38 from being pushed or moved by the toddler during feeding time.

In the same manner as packages 10, lid 34 may have a color that is indicative of a type of food contained therein. For example, if four packages 30 are provided, with each lid 34 having a different color, the colors of each package 30 may indicate whether the package 30 contains a protein (e.g., orange), a vegetable (e.g., green), a fruit (e.g., red), or a grain (e.g., yellow). Additionally, projected shape 36 on lid 34 may also be indicative of the contents of package 30 (e.g., a square shape for a yellow lid and a grain product, a circle shape for a green lid and a vegetable product, a star shape for an orange lid and a protein product, and a triangle shape for a red lid and a fruit product). The skilled artisan will appreciate that these combinations are simply examples of color/shape/food combinations and that any known combination may be used, so long as the combinations provide unique colors and shapes for each food group.

Similar to packages 10, packages 30 may also be multifunctional for feeding, education and play time purposes. For example, packages 30 may be education for the child in that matching the shapes of projections 36 to the shapes of projections 40 requires dexterity, shape recognition and matching abilities on the part of the toddler. Further, the present packages can provide ease of shopping and home inventory for a toddler's caregiver. In this manner, a caregiver can easily provide a balanced meal by providing one serving each of vegetables, fruits, proteins, and grains simply by selecting packages having different colors. Caregivers may also select a balanced meal for a toddler based on the color or shape scheme discussed above, stack the selected meal packages 30, and serve the meal to a toddler. This presentation makes meal time fun for the toddler, who may be allowed to “play” with packages 30 to unstick them, open them, self-feed, and then (if desired) play with or restack empty packages 30.

Caregivers can also easily piece together a nutritional meal for a toddler, by providing indicia 42 on body 32 that is indicative of the type of food contained in body 32.

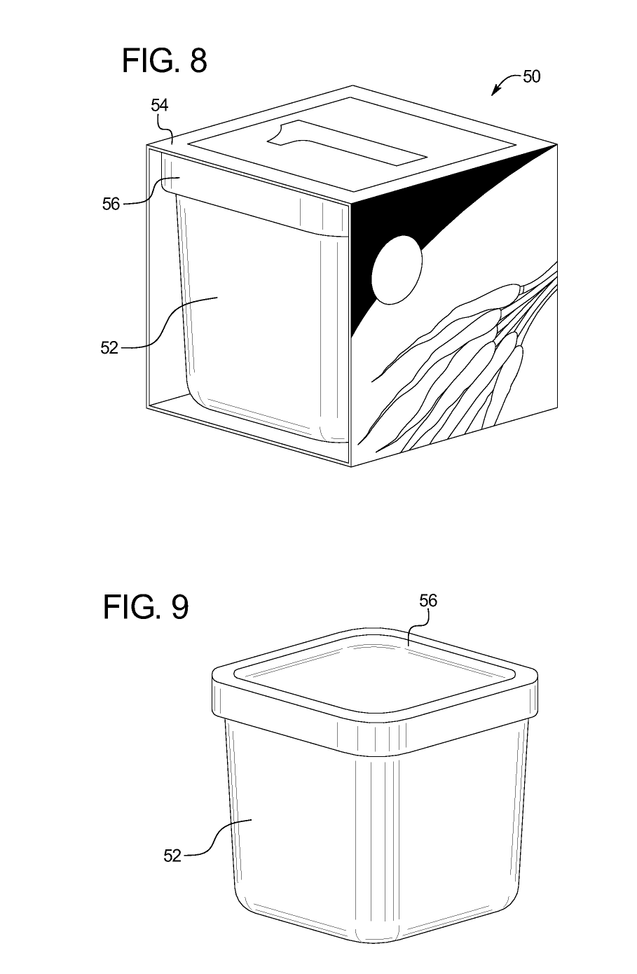

In another embodiment, and as shown in FIGS. 8-10, a package 50 for storing consumable products is provided. Package 50 includes a container having a body 52 that defines an interior compartment (not shown) and is housed in a sleeve 54. Although body 52 of package 50 is illustrated as being square in shape, body 52 of package 50 may define any shape that is known in the art. For example, body 52 may be a cylinder, a cube, a cuboid, a pyramid, a cone, a prism, oblong (e.g., oval), or combinations thereof, so long as body 52 is capable of housing a consumable product within an interior compartment. For ease of reference, and with this embodiment, body 52 will be discussed as being a square body 52. Body 52 is also not limited to any particular size so long as consumable products may be contained therein and may be easily handled by a toddler or a caregiver of a toddler. The skilled artisan will appreciate that the dimensions of package 50 may vary as desired or in accordance with manufacturing specifications or in accordance with the size and shape of the consumable products contained therein.

The interior compartment (not illustrated) of body 52, however, should have a size and shaped that allows a toddler to easily self-feed. For example, the interior compartment may have a circular or oval shape that will allow a toddler to reach into body 52 to remove consumable products housed therein to self-feed. Since the dexterity of toddlers is limited or not fine-tuned, a toddler may have a difficult time removing food from body 52 if the interior compartment has corners in which food may be lodged or stuck and require fine motor control to remove therefrom. In an embodiment, the interior compartment has a square shape with rounded corners. In an embodiment, body 52 may include more than one compartment.

Package 50 may also include a lid 56 that is sized and shaped to fit with body 52. Lid 56 is not limited to any particular shape or size, so long as lid 56 is capable of sealingly fitting to body 52 to prevent loss or contamination of a consumable product housed therein. In this manner, lid 56 may be mated with body 52 by snap-fitting, pressure-fitting, friction fitting, etc. Lid 56 may be fitted to body 52 in a resealing manner so that each time lid 56 is removed from body 52, it may be placed on body 52 again in a sealed manner. In an embodiment, lid 56 is a substantially flat lid, as illustrated in FIGS. 8-9. However, the skilled artisan will appreciate that lid 56 may have any shape known in the art.

Similar to previous embodiments, body 52 and/or lid 56 may be colored a color that is indicative of the nutritional contents of package 50. For example, body 52 and/or lid 56 may be colored orange to indicate that package 50 contains a protein. Alternatively, body 52 and/or lid 56 may be colored green to indicate that package 50 contains a vegetable, or red to indicate that package 50 contains a fruit, or yellow to indicate that package 50 contains a grain, etc.

Sleeve 54 may be made of any material that is capable of encasing body 52 and forming a rigid or semi-rigid structure. For example, sleeve 54 may be made of cardboard, paperboard, cardstock, fiberboard, lidstock, etc. Sleeve 54 may be one continuous piece of material, or may be a substantially flat blank that is folded and adhered to a portion of itself.

Sleeve 54 may also have coloring, shapes or indicia that are indicative of the contents of package 50. For example, the colors of sleeve 54 may indicate whether the package 50 contains a protein (e.g., orange), a vegetable (e.g., green), a fruit (e.g., red), or a grain (e.g., yellow). Additionally, a number on sleeve 54 may also be indicative of the contents of package 50 (e.g., the number “1” for a vegetable, the number “2” for a fruit, the number “3” for a protein, and the number “4” for a grain). The skilled artisan will appreciate that these combinations are simply examples of color/shape/food combinations and that any known combination may be used, so long as the combinations provide unique colors and shapes for each food group.

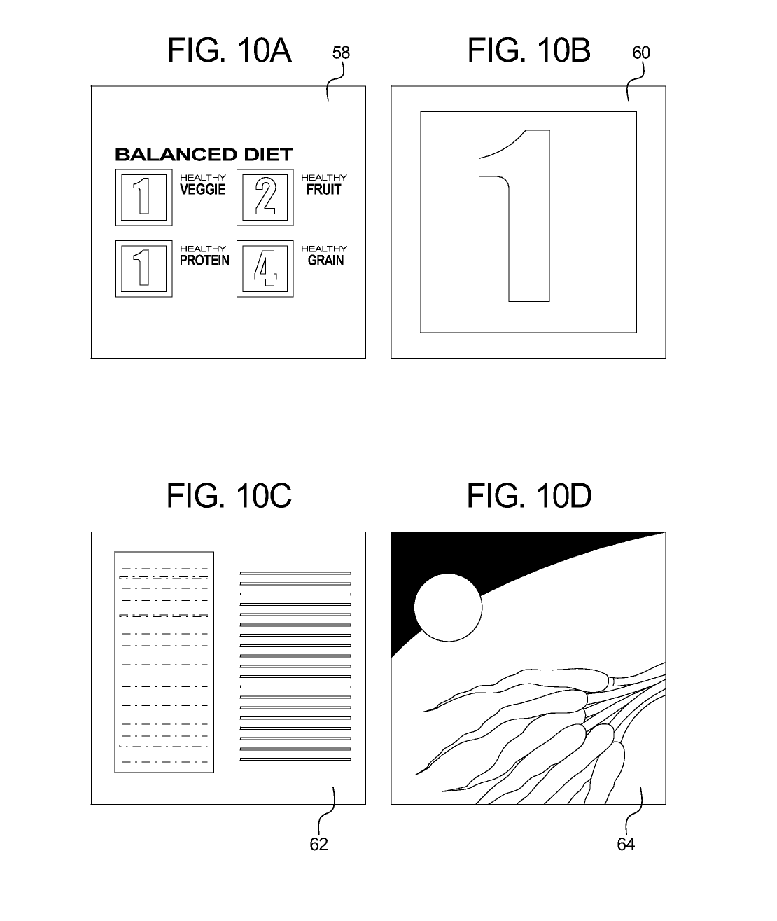

Such indicators may be located on different sides of sleeve 54, or may be combined on one side of sleeve 54. For example, and as is shown in FIGS. 8 and 10A-10D, each side of sleeve 54 may incorporate a different indicator. FIG. 10A, which may be on a back side of sleeve 54 includes information about providing a balanced diet. Specifically, FIG. 10A provides a “legend” that shows a specific color and number relating to vegetables, a specific color and number relating to proteins, a specific color and number relating to proteins and a specific color and number relating to grains. FIG. 10B provides a color and a number. To reinforce the appearance of a block for the entertainment of a child, the number “1” of FIG. 10B and the boarder around the number “1” may both be colored a specific color indicative of the contents of package 50. FIG. 10C may have a colored background that is indicative of the contents of package 50 (e.g., green for vegetables) and includes printed nutritional information thereon. FIG. 10D illustrates a bold image indicative of the contents of package 50 (e.g., carrots).

Therefore, in the present example, body 52 may be green in color, and sleeve 54 may have (i) a green colored number “1” and a green border on a top side, as shown in FIGS. 8 and 10b; (ii) a green background for a bottom side, which includes nutritional information; and (iii) an image of carrots on a front side. The skilled artisan will appreciate that other combinations of colors, numbers and indicia combinations may be used, so long as the colors, numbers and indicia are indicative of the contents of package 50. Additionally, and as would be known to the skilled artisan, alternatives to numbers may be used, while still achieving the same purpose (e.g., letters instead of numbers).

Similar to previous embodiments, FIGS. 8-10 illustrate packages 50 that are aesthetically appealing to toddlers and can serve multiple purposes. In this regard, toddlers will begin to associate blocks with meal times and may become excited about, and more patient with, meal times. Additionally, the toddler may be able to play with packages 50 either before, during or after meal time. Further, the packages shown in FIGS. 8-10 may also make it easier for a caregiver to shop for, and provide, nutritional and balanced meals to a toddler. In this manner, since the packages having indicia/colors/numbers/etc. that are indicative of the type of consumable product contained in the packages, caregivers can inventory a supply of toddler foods, or shop for additional toddler foods based on easily identifiable characteristics (e.g., colors, numbers, etc.).

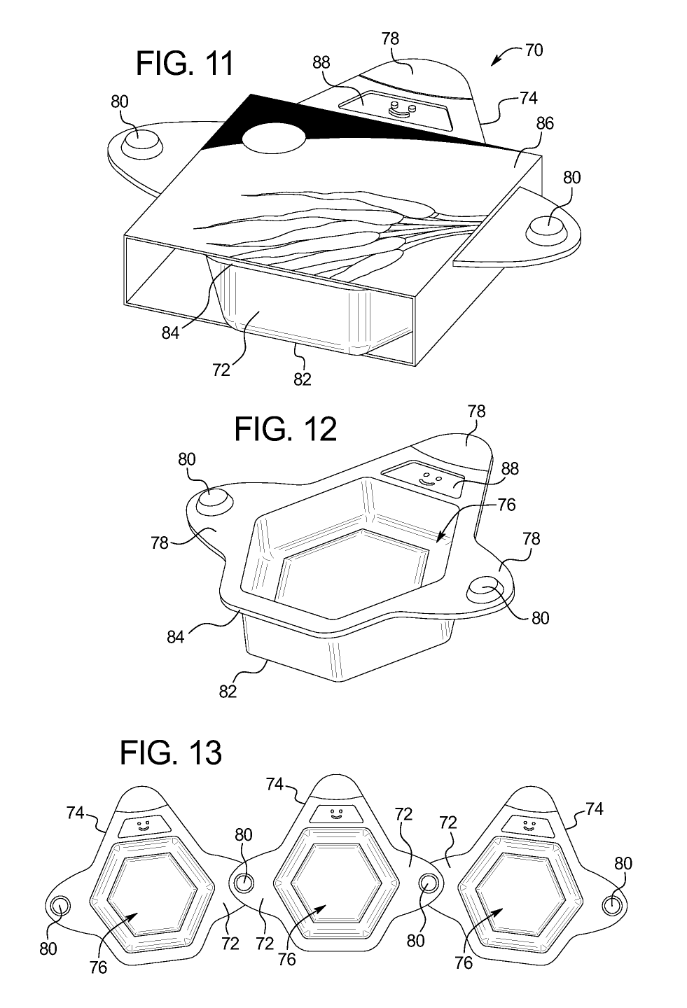

In yet another embodiment, and as shown in FIGS. 11-13, a package 70 for storing consumable products is provided. Package 70 includes a body 72 that defines a perimeter 74 and at least one interior compartment 76, and a sleeve 86. Body 72 may further define a hook (not illustrated) that may be used for hanging package 70 for display. Perimeter 74 of package 70 may define any shape that is easily recognized by a child, but is not a typical geometric shape. For example, in an embodiment illustrated in FIG. 1, perimeter 74 of package 70 defines an airplane shape. However, the skilled artisan will appreciate that the shape of perimeter 74 is not limited to an airplane and may include any shape that is easily recognizable to a child that is not a typical geometric shape.

As used herein, a “recognizable shape” means that the perimeter of the package body and/or the perimeter of the body forms a shape that is easily recognized by a child. For example, the shape may include, for example, an airplane, a clown, a doll, a dinosaur, a dog, a cat, a robot, etc. The shape may be recognizable from television, movies, books, plays, games, school, home, etc. Further, as used herein, a “typical geometric” shape is a shape that is commonly known and familiar to children including, for example, a circle, a triangle, a square, a rectangle, etc.

In addition to having a shape on perimeter 74, and to appeal to a toddler, body 72 may also include an embossed, debossed, printed, or sticker shape 88 that provides a fun, childlike feature to package 70. For example, and as shown in FIGS. 11-13, body 72 may include debossed smiley face shape 88 that children may find fun and which may increase the child's desire to self-feed or make the child excited for meal time.

In an embodiment, portions 78 of perimeter 74 allow for easier handling of package 70. For example, in FIGS. 11-13, portions 78 of perimeter 74 that represent the “wings” or the “head” of the airplane aid in handling of package 70. In an embodiment these gripping portions 78 of perimeter 74 may also be used to aid in standing the product upright for marketing purposes. Gripping portions 78 may also include a projection 80 that may be used to connect multiple packages 70, as shown in FIG. 13. Projection 80 may be stamped or otherwise integrally formed into body 72 such that projection 80 has an embossed side on a top portion of body 72 and a debossed side on a bottom portion of body 72. In this manner, the embossed side of projection 80 of a first package 70 is able to mate with a debossed side of projection 80 of a second package 70. Further, the debossed side of a second projection 80 of the first package 70 is able to mate with an embossed side of projection 80 of a third package 70.

In an embodiment, package 70 may be stood upright for storage or display. For optimum packaging and shipping to a consumer or to retail stores, it is beneficial that package 70 is able to stand substantially upright. Further, it is advantageous for marketing purposes to display package 70 on a store shelf in a substantially upright position such that a consumer is able to identify product information on the front of package 70, the recognizable shape of package 70 is readily visible to the consumer, a toddler/caregiver can easily view the shape of package 70, etc.

For example, a bottom surface 82 of compartment 76 may, in combination with a portion 84 of perimeter 74, form a plane on which package 70 stands. In other words, as long as package 70 defines a plane on which package 70 can rest, the shape of perimeter 74 and/or compartment 76 is immaterial. In an embodiment, package 70 may rest in a substantially vertical or upright position or may rest in a position that tilts toward or away from a consumer, depending on the shape of package 70. Regardless of the shape of package 70, if intended to rest on a bottom surface, package 70 must be able to rest in a stable manner on the plane. In other words, package 70 must be constructed and arranged so that it will not easily fall over when filled with consumable products.

In another embodiment, package 70 may be configured to hang vertically from a display rack in a retail store. As discussed above, body 72 may define a hook (not illustrated) that is so constructed and arranged to receive a hanger that allows package 70 to hang from a display rack. The skilled artisan will appreciate that the shape and size of the hook is not critical. For example, in an embodiment, the hook may be a hole in a top portion of body 72 that corresponds to a location of the airplane's head or face. The hook may be entirely defined by body 72 such that the hook does not form part of perimeter 74.

Alternatively, however, perimeter 74 may include an integral hook (not illustrated) that is so constructed and arranged to form a portion of perimeter 74. In other words, the integral hook may be formed continuously with a portion of perimeter 74 such that it shares a boundary with perimeter 74. For example, in an embodiment where package 70 generally has an airplane shape, the hook may form a portion of perimeter 74 located at a top of package 70 and may have a curved configuration that functions as a hook but looks like hair on the airplane. The skilled artisan will appreciate that the integral hook is not limited to any particular size or shape so long as the integral hook allows a display hanger to pass therethrough to hang package 70.

In addition to standing substantially upright and hanging, package 70 may also be configured to lay substantially flat on a surface, as shown in FIG. 11. In an embodiment, sleeve 86 and body 72 are substantially flat and allow package 70 to lay on a flat surface.

Similar to previous embodiments, body 72 may be colored a color that is indicative of the nutritional contents of package 70. For example, body 72 may be colored orange to indicate that package 70 contains a protein. Alternatively, body 72 may be colored green to indicate that package 70 contains a vegetable, or red to indicate that package 70 contains a fruit, or yellow to indicate that package 70 contains a grain. By providing body 72 with a color indicative of the contents of package 70 in combination with projections 80, a caregiver may easily provide a toddler with a balanced meal simply by selecting one of each different color of package 70 and connecting them together for the toddler, as shown in FIG. 13.

Sleeve 86 may be made of any material that is capable of encasing body 72 and forming a rigid or semi-rigid structure. For example, sleeve 86 may be made of cardboard, paperboard, cardstock, lidstock, fiberboard, etc. Sleeve 86 may be one continuous piece of material, or may be a substantially flat blank that is folded and adhered to a portion of itself.

Sleeve 86 may also have coloring, shapes or indicia that are indicative of the contents of package 70. For example, the colors of sleeve 86 may indicate whether the package 70 contains a protein (e.g., orange), a vegetable (e.g., green), a fruit (e.g., red), or a grain (e.g., yellow). Additionally, an image on sleeve 86 may also be indicative of the contents of package 70 (e.g., carrots). The skilled artisan will appreciate that these combinations are simply examples of color/shape/food combinations and that any known combination may be used, so long as the combinations provide unique colors and shapes for each food group.

Such indicators may be located on different sides of sleeve 86, or may be combined on one side of sleeve 86. For example, and as is shown in FIG. 11, an image of the contents of package 70 (e.g., carrots) may be present on a front side of sleeve 86, while nutritional information may be present on a back side (not shown) of sleeve 86. The combinations of colors, images, and other indicators may be the same as embodiments previously discussed.

Therefore, in the present example, body 72 may be green in color, and sleeve 86 may have (i) a green background for a bottom side, which includes nutritional information; and (ii) an image of carrots on a front side. The skilled artisan will appreciate that other combinations of colors, numbers indicia, etc. may be used, so long as the colors, numbers and indicia are indicative of the contents of package 70.

In an embodiment, package 70 may include a lid (not illustrated) or other form of closure such as a removable closure to properly store the consumable products therein. A removable closure (not shown) such as, for example, a transparent film, cardboard, paperboard, cardstock, lidstock, fiberboard, etc, may be sealed onto top surface of body 72, and may sealably close compartment 76 from an ambient environment. In addition to separation of consumable products, the removable closure may also be used to keep the products fresh and to extend the shelf life of the products. Any conventional sealing technique known in the art may be used to seal the removable closure onto a top surface of body 72. The techniques may include, but are not limited to, conductive heating, cold sealing, heat sealing, heat activated adhesive, etc.

The packages of the present disclosure provide new, simplified, and contemporary ways to communicate the contents of the packages, and to provide balanced meals to a toddler. Specifically, the present packages provide a simplified shopping experience for caregivers that cut down on time needed to decipher the nutritional content or types of foods contained in a package. Instead, caregivers can simply shop by colors, numbers, letters and other easy identifiers. Further, the colors, numbers, letters, etc. found on the packages quickly and simply communicate information to caregivers as to how to provide a balanced diet to toddlers.

Additionally, the packages of the present disclosure are aesthetically appealing to toddlers and can serve multiple purposes. In this regard, toddlers will begin to associate fun and learning with meal times and may become excited about, and more patient with, meal times. Additionally, the toddler may be able to play with the packages of the present disclosure either before, during or after meal time.

The skilled artisan will appreciate that any of the embodiments disclosed herein may include any of the features illustrated or described by any other embodiments disclosed herein. In this manner, for example, the packages of FIGS. 1-3 may also share similar features to the packages of FIG. 8-10 or 11-13.

In yet another embodiment, Applicants have discovered an efficient and low cost manner in which to manufacture the packages of the present disclosure. The skilled artisan will appreciate that the manufacturing methods disclosed herein may be used with the packages of the present disclosure as well as similar packages that may or may not include all of the features of the packages disclosed above.

Applicants have found that manufacturing the packages of the present disclosure as connected packages separated by a perforation provides several benefits over manufacturing the packages of the present disclosure as single packages. Indeed, the two trays would fit the footprint on the current manufacturing line, but would provide improvements thereto. For example, two trays may be connected with a perforation to allow for easy separation of the two pack. This design allows for a lower manufacturing cost, making the project feasible to achieve the a la carte concept of individual components for customization. Even further, current single compartment designs that are not perforated and connected are limited to six trays per carrier plate on manufacturing line, and do not have an educational or child engagement component.

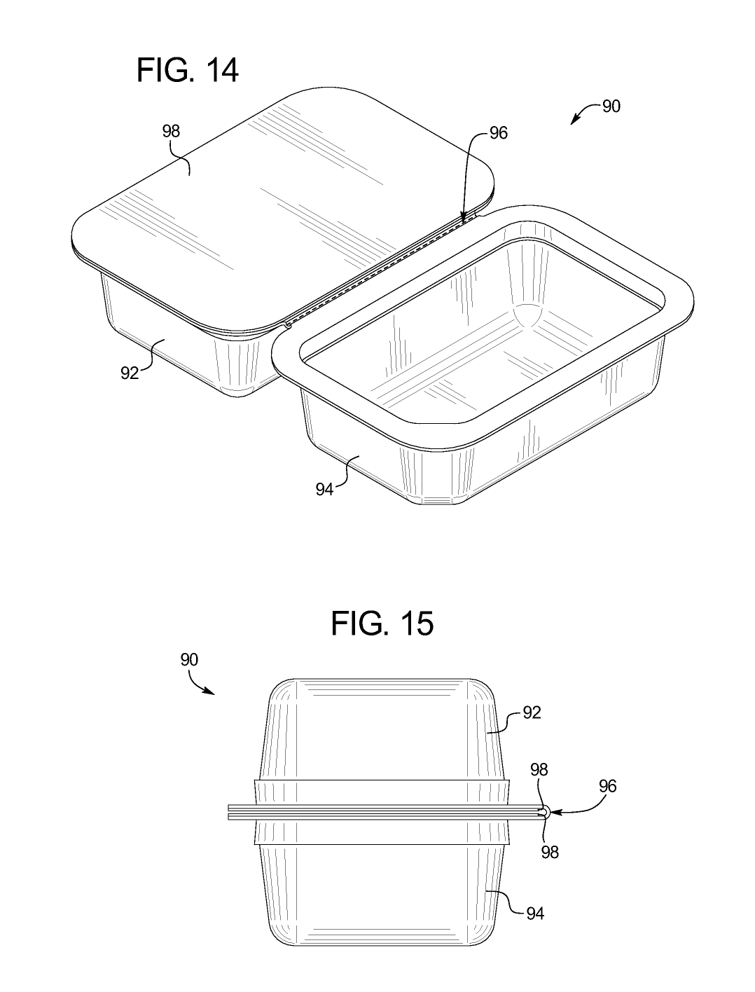

In contrast, however, the two-pack perforated design 90 having a first tray 92 and a second tray 94, as shown in FIGS. 14-15, allows for lower manufacturing cost with design set up on carrier plate. This design would allow for eight trays per carrier plate on a manufacturing line, which is much more cost effective than providing fewer trays per carrier plate. The design also meets customization desires from consumers by having individual trays of each food category (grain, protein, vegetable) to allow a toddler/caregiver to assemble balanced meals or to eat specifically required dietary components.

The two-pack perforated design 90 may be arranged in at least two configurations. In a first embodiment, as shown in FIG. 14, first and second trays 92, 94 may be side by side and separated by a perforation 96. In a second configuration, the two-pack perforated design 90 may be folded at perforation 96 so that first tray 92 rests in an inverted position on a top surface of second tray 94. In both of these configurations, trays 92, 92 remain connected via perforation 96. In embodiments wherein the trays remain connected, the trays may be packaged and shipped with lids similar to those shown in FIGS. 4-7 for separation and assembly by the consumer. Alternatively, trays 92, 94 may be manufactured connected by perforation 96 and then separated prior to packaging and shipping to a retailer or a consumer. In such an embodiment, trays 92, 94 may have lids similar to those shown in FIGS. 4-7 placed on them prior to packaging and shipping to a retailer or a consumer.

Trays 92, 94 may be received from a supplier with perforation 96. As such, during the manufacturing procedure, trays 92, 94 will need to be filled and have a removable cover 98 adhered thereto. Cover 98 may be a film, cardboard, paperboard, cardstock, lidstock, fiberboard, etc. To ensure separability of trays 92, 94 cover 98 may require perforation or die cutting during manufacturing. Cover 98 may also include a cut or a perforation (not shown) located in a position that corresponds to perforation 96 of trays 92, 94.

As mentioned previously, all of the features discussed above with respect to the packages of the present disclosure may be utilized with trays 92, 94. For example, trays 92, 94 may include a shape design embossed on a bottom of trays 92, 94 to provide an educational and engaged experience for the child while the child matches shapes and/or assembles colors, numbers, letters, etc. to create a meal.

As such, Applicants are able to provide a retort/shelf stable packaging design with a perforated film for a two-pack. In such an embodiment, trays 92, 94 are connected via the cover 98 (e.g., lidstock), which provides manufacturing benefits over, and which is different from, current two-pack configurations.

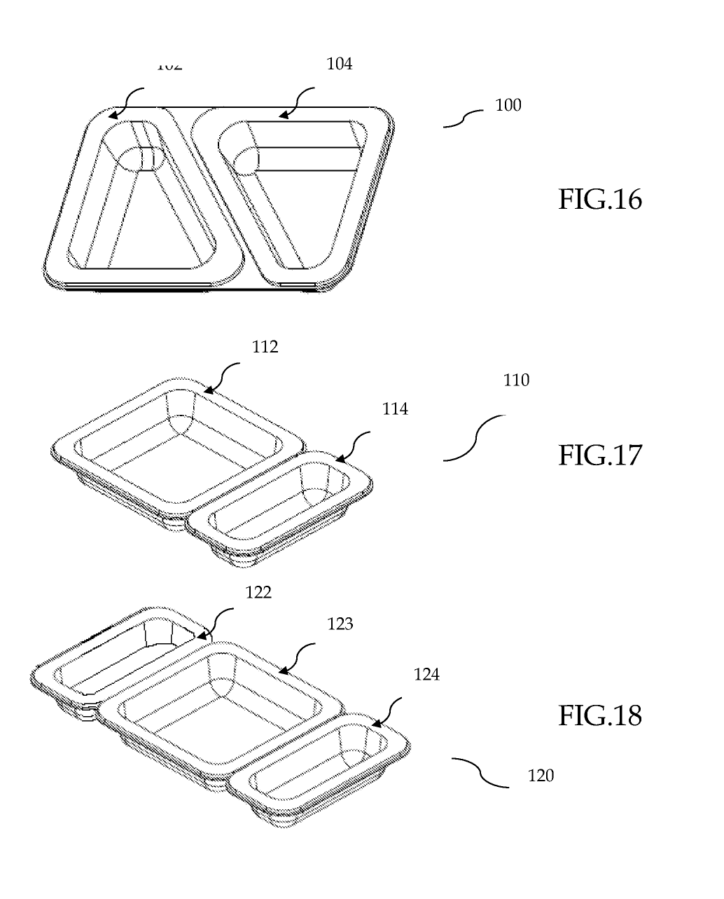

The two-pack perforated design 100 having a first tray 102 and a second tray 104, as shown in FIG. 16, illustrates an alternative shape for the trays. The design also meets customization desires from consumers by having individual trays of each food category (grain, protein, vegetable) to allow a toddler/caregiver to assemble balanced meals or to eat specifically required dietary components. In one embodiment, each food category (grain, protein, vegetable) can have a different shape.

The two-pack perforated design 100 may be arranged in any configurations. In a first embodiment, as shown in FIG. 16, first and second trays 102, 104 may be side by side and separated by a perforation. In this configuration, trays 102, 104 remain connected via perforation. In embodiments wherein the trays remain connected, the trays may be packaged and shipped with lids similar to those shown in FIGS. 4-7 for separation and assembly by the consumer. Alternatively, trays 102, 104 may be manufactured connected by perforation and then separated prior to packaging and shipping to a retailer or a consumer. In such an embodiment, trays 102, 104 may have lids similar to those shown in FIGS. 4-7 placed on them prior to packaging and shipping to a retailer or a consumer.

Trays 102, 104 may be received from a supplier with perforation. As such, during the manufacturing procedure, trays 102, 104 will need to be filled and have a removable cover adhered thereto. The removeable cover may be a film, cardboard, paperboard, cardstock, lidstock, fiberboard, etc. To ensure separability of trays 102, 104 the cover may require perforation or die cutting during manufacturing. The cover may also include a cut or a perforation located in a position that corresponds to perforation of trays 102, 104.

As mentioned previously, all of the features discussed above with respect to the packages of the present disclosure may be utilized with trays 102, 104. For example, trays 102, 104 may include a shape design embossed on a bottom of trays 102, 104 to provide an educational and engaged experience for the child while the child matches shapes and/or assembles colors, numbers, letters, etc. to create a meal.

As such, Applicants are able to provide a retort/shelf stable packaging design with a perforated film for a two-pack. In such an embodiment, trays 102, 104 are connected via the cover (e.g., lidstock).

The two-pack perforated design 110 having a first tray 112 and a second tray 114, as shown in FIG. 17, illustrates an embodiment wherein the trays of the two-pack design can be of different sizes. The design also meets customization desires from consumers by having individual trays of each food category (grain, protein, vegetable) to allow a toddler/caregiver to assemble balanced meals or to eat specifically required dietary components. In one embodiment, each food category (grain, protein, vegetable) can have a different size.

The two-pack perforated design 110 may be arranged in any configurations. In an embodiment, as shown in FIG. 17, first and second trays 112, 114 may be side by side and separated by a perforation. In this configuration, trays 112, 114 remain connected via perforation. In embodiments wherein the trays remain connected, the trays may be packaged and shipped with lids similar to those shown in FIGS. 4-7 for separation and assembly by the consumer. Alternatively, trays 112, 114 may be manufactured connected by perforation and then separated prior to packaging and shipping to a retailer or a consumer. In such an embodiment, trays 112, 114 may have lids similar to those shown in FIGS. 4-7 placed on them prior to packaging and shipping to a retailer or a consumer.

Trays 112, 114 may be received from a supplier with perforation. As such, during the manufacturing procedure, trays 112, 114 will need to be filled and have a removable cover adhered thereto. The removable cover may be a film, cardboard, paperboard, cardstock, lidstock, fiberboard, etc. To ensure separability of trays 112, 114 the cover may require perforation or die cutting during manufacturing. The cover may also include a cut or a perforation located in a position that corresponds to perforation of trays 112, 114.

As mentioned previously, all of the features discussed above with respect to the packages of the present disclosure may be utilized with trays 112, 114. For example, trays 112, 114 may include a shape design embossed on a bottom of trays 112, 114 to provide an educational and engaged experience for the child while the child matches shapes and/or assembles colors, numbers, letters, etc. to create a meal.

As such, Applicants are able to provide a retort/shelf stable packaging design with a perforated film for a two-pack. In such an embodiment, trays 102, 104 are connected via the cover (e.g., lidstock).

The three-pack perforated design 120 having a first tray 122, a second tray 123, and a third tray 124, as shown in FIG. 18, illustrates an embodiment wherein the trays of the three-pack design can be of different sizes. In an alternative embodiment, the three-pack design can have trays being of a single size. In another embodiment, the three-pack design can have trays being of two sizes. In further embodiment, the three-pack design can have trays being of three sizes. The design also meets customization desires from consumers by having individual trays of each food category (grain, protein, vegetable) to allow a toddler/caregiver to assemble balanced meals or to eat specifically required dietary components. In one embodiment, each food category (grain, protein, vegetable) can have a different size.

The three-pack perforated design 120 may be arranged in any configurations. In a first embodiment, as shown in FIG. 18, first, second, and third trays 122, 123, 124 may be side by side and separated by a perforation. In this configuration, trays 122, 123, 124 remain connected via perforation. In embodiments wherein the trays remain connected, the trays may be packaged and shipped with lids similar to those shown in FIGS. 4-7 for separation and assembly by the consumer.

Trays 122, 123, 124 may be received from a supplier with perforation. As such, during the manufacturing procedure, trays 122, 123, 124 will need to be filled and have a removable cover adhered thereto. The removable cover may be a film, cardboard, paperboard, cardstock, lidstock, fiberboard, etc. To ensure separability of trays 122, 123, 124 the cover may require perforation or die cutting during manufacturing. The cover may also include a cut or a perforation located in a position that corresponds to perforation of trays 122, 123, 124.

As mentioned previously, all of the features discussed above with respect to the packages of the present disclosure may be utilized with trays 122, 123, 124. For example, trays 122, 123, 124 may include a shape design embossed on a bottom of trays 122, 123, 124 to provide an educational and engaged experience for the child while the child matches shapes and/or assembles colors, numbers, letters, etc. to create a meal.

As such, Applicants are able to provide a retort/shelf stable packaging design with a perforated film for a three-pack. In such an embodiment, trays 122, 123, 124 are connected via the cover (e.g., lidstock).

In yet another embodiment, and as shown in FIGS. 19-23, a package 170 for storing consumable products is provided. Package 170 includes a body 172 that defines a perimeter 174 and at least one interior compartment 176. Body 172 may further define a hook (not illustrated) that may be used for hanging package 170 for display. Perimeter 174 of package 170 may define any shape that contains at least two projections 180 to allow for removable connecting two packages 170. The skilled artisan will appreciate that the shape of perimeter 174 is not limited.

Body 172 may also include an embossed, debossed, printed, or sticker shape that provides a fun, childlike feature to package 170. For example, body 172 may include debossed smiley face shape that children may find fun and which may increase the child's desire to self-feed or make the child excited for meal time.

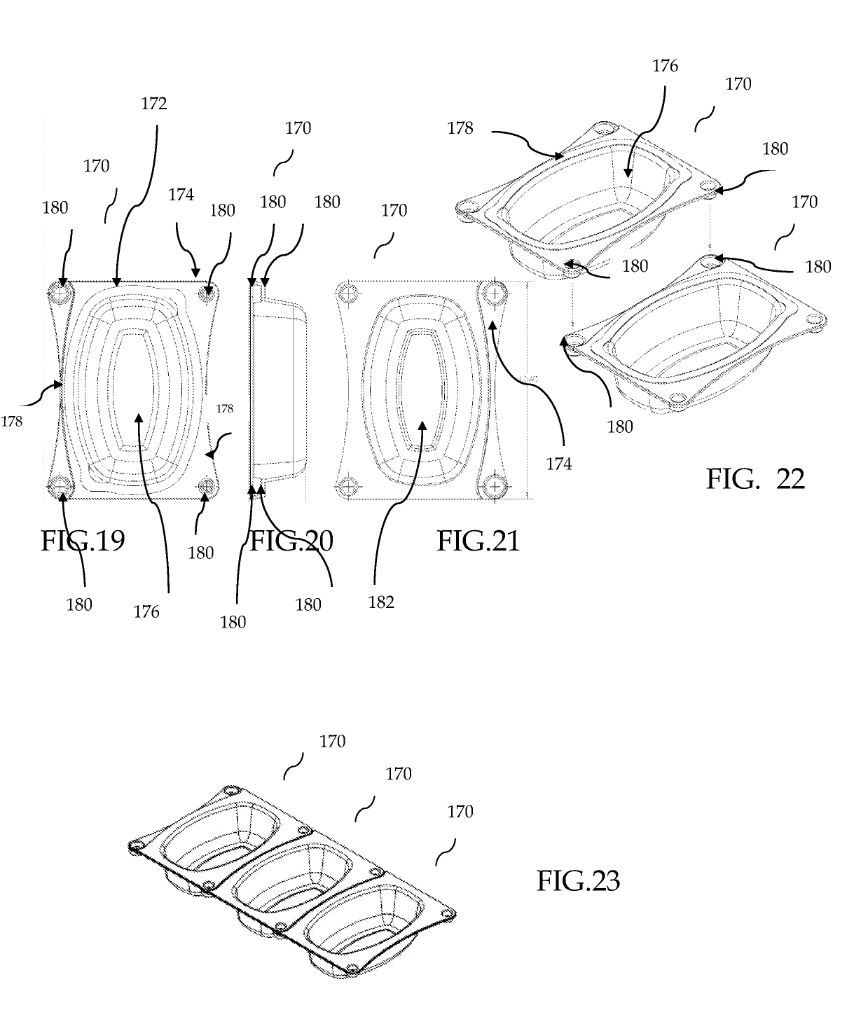

In an embodiment, portions 178 of perimeter 174 allow for easier handling of package 170. For example, portions 178 of perimeter 174 that represent the “sides” of the package aid in stability of package 170 when two or more are connected at projection 180 as illustrated in FIG. 22, wherein portions 178 of two adjacent packages 170 will overlap at least in part. In an embodiment these gripping portions 178 of perimeter 174 may also be used to aid in standing the product upright for marketing purposes. Gripping portions 178 include a projection 180 that may be used to connect multiple packages 170, as shown in FIG. 22. Projection 180 may be stamped or otherwise integrally formed into body 172 such that projection 180 has an embossed side on a top portion of body 172 and a debossed side on a bottom portion of body 172. In this manner, the embossed side of projection 180 of a first package 170 is able to mate with a debossed side of projection 180 of a second package 170. Further, the debossed side of a second projection 180 of the first package 170 is able to mate with an embossed side of projection 180 of a third package 170.

In an embodiment, package 170 may be stood upright for storage or display. For optimum packaging and shipping to a consumer or to retail stores, it is beneficial that package 170 is able to stand substantially upright. Further, it is advantageous for marketing purposes to display package 170 on a store shelf in a substantially upright position such that a consumer is able to identify product information on the front of package 170, the recognizable shape of package 170 is readily visible to the consumer, a toddler/caregiver can easily view the shape of package 170, etc.

For example, a bottom surface 182 of compartment 176 may, in combination with a portion 84 of perimeter 174, form a plane on which package 170 stands. In other words, as long as package 170 defines a plane on which package 170 can rest, the shape of perimeter 174 and/or compartment 176 is immaterial. In an embodiment, package 170 may rest in a substantially vertical or upright position or may rest in a position that tilts toward or away from a consumer, depending on the shape of package 170. Regardless of the shape of package 170, if intended to rest on a bottom surface, package 170 must be able to rest in a stable manner on the plane. In other words, package 170 must be constructed and arranged so that it will not easily fall over when filled with consumable products.

In another embodiment, package 170 may be configured to hang vertically from a display rack in a retail store. As discussed above, body 172 may define a hook (not illustrated) that is so constructed and arranged to receive a hanger that allows package 170 to hang from a display rack. The skilled artisan will appreciate that the shape and size of the hook is not critical. For example, in an embodiment, the hook may be a hole in a top portion of body 172. The hook may be entirely defined by body 172 such that the hook does not form part of perimeter 174.

Alternatively, however, perimeter 174 may include an integral hook (not illustrated) that is so constructed and arranged to form a portion of perimeter 174. In other words, the integral hook may be formed continuously with a portion of perimeter 174 such that it shares a boundary with perimeter 174. For example, in an embodiment where package 170 generally has an airplane shape, the hook may form a portion of perimeter 174 located at a top of package 170 and may have a curved configuration that functions as a hook but looks like hair on the airplane. The skilled artisan will appreciate that the integral hook is not limited to any particular size or shape so long as the integral hook allows a display hanger to pass therethrough to hang package 170.

In addition to standing substantially upright and hanging, package 170 may also be configured to lay substantially flat on a surface.

Similar to previous embodiments, body 172 may be colored a color that is indicative of the nutritional contents of package 170. For example, body 172 may be colored orange to indicate that package 170 contains a protein. Alternatively, body 172 may be colored green to indicate that package 170 contains a vegetable, or red to indicate that package 170 contains a fruit, or yellow to indicate that package 170 contains a grain. By providing body 172 with a color indicative of the contents of package 170 in combination with projections 80, a caregiver may easily provide a toddler with a balanced meal simply by selecting one of each different color of package 170 and connecting them together for the toddler, as shown in FIG. 23.

In an embodiment, package 170 may include a lid (not illustrated) or other form of closure such as a removable closure to properly store the consumable products therein. A removable closure (not shown) such as, for example, a transparent film, cardboard, paperboard, cardstock, lidstock, fiberboard, etc, may be sealed onto top surface of body 172, and may sealably close compartment 176 from an ambient environment. In addition to separation of consumable products, the removable closure may also be used to keep the products fresh and to extend the shelf life of the products. Any conventional sealing technique known in the art may be used to seal the removable closure onto a top surface of body 172. The techniques may include, but are not limited to, conductive heating, cold sealing, heat sealing, heat activated adhesive, etc.

As mentioned previously, all of the features discussed above with respect to the packages of the present disclosure may be utilized with package 170. For example, package 170 may include a shape design embossed on a bottom of trays package 170 to provide an educational and engaged experience for the child while the child matches shapes and/or assembles colors, numbers, letters, etc. to create a meal.

In an embodiment, the two or more trays will be produced separately and welded together. This will allow for two products that need different processing and/or packaging to be added together.

In an embodiment, the two or more trays will different tray depths.

In an embodiment, the two or more trays will different diameters and different tray depths.

In an embodiment, the two or more trays will contain different products.

In an embodiment, the two or more trays will contain the same product.

In an embodiment, the two or more trays will contain items that will be used together. For example, in one embodiment, one tray can contain pasta and the other tray can contain a sauce. A further embodiment would be one tray contains pasta, one tray contains a tomato sauce, and another tray contains an Alfredo sauce giving the consumer an option to use one sauce or the other or combine the sauces. Further, having the separate containers would allow the consumer to add only the amount of sauce they want at the time of serving, giving it a more homemade feel. In an embodiment, one tray would contain milk and another would contain cereal. In a further embodiment, one tray would contain Cheese sauce and another would contain vegetables. In an embodiment, one tray would contain yogurt and another would contain cereal. In another embodiment, one tray would contain fruit and another would contain cereal. In a further embodiment, one tray would contain fruit and another would contain yogurt. In an embodiment, one tray would contain biscuits and another would contain gravy or one tray and contain meat and the other tray can contain gravy. In another embodiment, one tray would contain a breakfast meat, such as sausage, ham, or bacon, and another could contain oatmeal, eggs, French toast, cereal or pancakes. In a further embodiment, one tray would contain soup and another could contain and entree. A further embodiment would be one tray contains vegetables, one tray contains a dip such as hummus, and another tray contains a ranch dip

In an embodiment, at least one of the two or more trays will contain items that will be used together. For example, in one embodiment, the tray can contain pasta and a pouch with sauce in it.

In an embodiment, the two or more trays will contain items for different parts of the meal. For example, in one embodiment, one tray can contain an entrée, and the other tray can contain dessert. A further embodiment would be one tray can contain an appetizer, and the other tray can contain dessert. Another embodiment would be one tray can contain an appetizer, another tray contains the entrée and another tray can contain dessert.

In an embodiment, the two or more trays will contain items that require different processing. For example, in one embodiment, one tray can contain an entrée that requires heating, and the other tray can contain dessert that requires freezing. A further embodiment would be one tray can contain chips that do not need any heating or cooling, and the other tray can contain a dipping sauce that can be heated or cooled.

In an embodiment, the two or more trays are perforated by laser cutting.

In an embodiment, the two or more trays are perforated and the lid stock is cut by laser cutting.

In an embodiment, the two or more trays are perforated after being heat treated. In an embodiment the heat treating is retort processing.

In an embodiment, the two or more trays are separated after being heat treated. In an embodiment the heat treating is retort processing.

In an embodiment, the two or more trays can contain two or more of the meals for the day. For example, one tray can contain breakfast, one tray can contain lunch, one tray can contain a snack, and/or one tray can contain dinner.

In an embodiment, methods for using packages of the present disclosure are also provided. For example, in an embodiment, a method for providing a child with a balanced meal is provided. The method includes providing at least two different packages, each package comprising (i) a body comprising a surface defining a recessed portion having a shape, the body being configured to house a consumable product and (ii) a lid comprising a surface defining a projection having a shape and a size that corresponds to the shape and size of the recessed portion, and a color that corresponds to a type of the consumable product. The method further includes serving the child a meal comprising at least one of each of the different packages.

In still yet another embodiment, a method for providing a child with a balanced meal is provided. The method includes providing at least two different packages, each package comprising (i) a body comprising a surface defining a recessed portion having a shape, the body being configured to house a consumable product, and (ii) a lid comprising a surface defining a projection having a shape and a size that corresponds to the shape and size of the recessed portion, and a color that is indicative of a type of the consumable product. The method further includes providing a feeding pad comprising a substantially flat surface having at least one projection having a shape and a size that corresponds to the shape and size of the recessed portion of the body, matching the shape of the recessed portion of the body with at least one of the projections of the feeding pad, and placing the package on the feeding pad by mating the matched recessed portion of the body with the matching at least one projection of the feeding pad.

In another embodiment, a method for providing a child with a balanced meal is provided. The method includes providing at least two different packages, each package comprising (i) a container for housing a consumable product, the container having a color that corresponds to a type of the consumable product housed by the container, and (ii) a sleeve configured to house the container, the sleeve having at least four sides, each of the four sides comprising an indicia. The method further includes serving the child a meal comprising at least one of each of the different packages.

In yet another embodiment, a method for providing a child with a balanced meal is provided. The method includes providing at least two different packages, each package comprising a body defining at least one interior compartment for housing a consumable product, first and second projections extending from the body, and a perimeter having a shape that resembles an airplane, wherein the first projection is located in a location that corresponds to a first wing of the airplane-shaped perimeter and the second projection is located in a location that corresponds to a second wing of the airplane-shaped perimeter. The method further includes attaching a first projection of a first package to a second projection of the second package, and serving the child a meal comprising the attached first and second packages.

In still yet another embodiment, a method for marketing consumable products is provided. The method includes providing a package comprising (i) a body comprising a surface defining a recessed portion having a shape, the body being configured to house a consumable product and (ii) a lid comprising a surface defining a projection having a shape and a size that corresponds to the shape and size of the recessed portion, and a color that corresponds to a type of the consumable product. The method further includes placing the package on a retail shelf.

In another embodiment, a method for marketing consumable products is provided. The method includes providing a consumable product package kit comprising (i) a body comprising a surface defining a recessed portion having a shape, the body being configured to house a consumable product, (ii) a lid comprising a surface defining a projection having a shape and a size that corresponds to the shape and size of the recessed portion, and a color that is indicative of a type of the consumable product, and (iii) a feeding pad comprising a substantially flat surface having at least one projection having a shape and a size that corresponds to the shape and size of the recessed portion of the body. The method further includes placing the consumable product package kit on a retail shelf.

In yet another embodiment, a method for marketing consumable products is provided. The method includes providing a package comprising (i) a container for housing a consumable product, the container having a color that corresponds to a type of the consumable product housed by the container, and (ii) a sleeve configured to house the container, the sleeve having at least four sides, each of the four sides comprising an indicia. The method further includes placing the consumable product package kit on a retail shelf.

In still yet another embodiment, a method for marketing consumable products is provided. The method includes providing a package comprising a body defining at least one interior compartment for housing a consumable product, first and second projections extending from the body, and a perimeter having a shape that resembles an airplane, wherein the first projection is located in a location that corresponds to a first wing of the airplane-shaped perimeter and the second projection is located in a location that corresponds to a second wing of the airplane-shaped perimeter. The method further includes placing the consumable product package kit on a retail shelf.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A package comprising:
a body defining an interior configured to house a consumable product and comprising a bottom surface defining a recessed portion having a shape; and
a lid comprising a surface defining a projection having a shape and a size that corresponds to a shape and size of the recessed portion on the body, and
a color that corresponds to a type of the consumable product housed by the body.

2. The package according to claim 1, wherein the recessed portion of the body has a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, and combinations thereof; and
wherein the projection of the lid has a shape selected from the group consisting of a circle, square, rectangle, triangle, quadrilateral, pentagon, hexagon, heptagon, octagon, nonagon, decagon, hexadecagon, icosagon, star, ellipse, semicircle, crescent, flower, and combinations thereof.

3. The package according to claim 1, wherein the projection of the lid is sized slightly smaller than the recessed portion of the body such that the projection of the lid may be inserted into the recessed portion of the body.

4. The package according to claim 1, wherein the color of the lid is different for packages housing a protein, a vegetable, a grain, and a fruit.

5. The package according to claim 1, wherein the body , the lid, or the body and lid further comprises:
a gripping portion; a gripping portion comprising dimple grips; a gripping portion comprising a shape; an indicia; or combinations thereof.

6. The package according to claim 1, wherein the body, the lid, or the body and lid comprises at least one indicia, wherein the indicia is placed on the body, the lid, or the body and lid by a method selected from the group consisting of embossing, debossing, printing, engraving, a sticker, and combinations thereof; and
wherein the indicia is at least one of: an image that corresponds to a type of consumable product housed by the body, a color that corresponds to a type of consumable product housed by the body, a child-like indicia, a smiley face, a letter, a number, an image of a vegetable, an image of a fruit, an image of a grain, an image of a protein, nutritional information.

7. The package according to claim 1, wherein the multiple uses include at least use as a feeding device and use as a toy.

8. The package according to claim 1, further comprising:
a feeding pad comprising a substantially flat surface having at least one projection having a shape and a size that corresponds to a shape and size of the recessed portion of the body, the lid or the body and lid;
a sleeve configured to surround at least a portion of the package, the sleeve having at least four sides, each of the four sides comprising an indicia; or
combinations thereof.

9. The package according to claim 8, wherein the surface of the feeding pad has a color that is different than a color of the projection on the feeding pad.

10. The package according to claim 8, wherein the feeding pad comprises a plurality of projections.

11. The package according to claim 8, wherein each of the plurality of projections has a different shape, a different color, or combinations thereof.

12. The package according to claim 8, wherein the color, shape, or color and shape, of the projections corresponds to type of consumable product housed by the body of the package.

13. The package according to claim 8, wherein the feeding pad is made of a no-skid material.

14. The package according to claim 8, wherein the package is configured to aid in providing a balanced meal to a toddler.

15. The package according to claim 8, wherein the multiple uses include at least use as a feeding device and use as a toy.

16. The package according to claim 8, wherein the indicia is placed on the sleeve by a method selected from the group consisting of embossing, debossing, printing, engraving, a sticker, and combinations thereof; and
wherein the indicia on the sleeve is at least one of: an image that corresponds to a type of consumable product housed by the body, a color that corresponds to a type of consumable product housed by the body, a child-like indicia, a smiley face, a letter, a number, an image of a vegetable, an image of a fruit, an image of a grain, an image of a protein, nutritional information.

17. The package according to claim 8, wherein a first side of the sleeve comprises an image that corresponds to the consumable product housed by the container, a second side of the sleeve comprises a number that corresponds to the consumable product housed by the container, a third side of the sleeve comprises a color that corresponds to the consumable product housed by the container, and a fourth side of the sleeve comprises a legend containing elements for a balanced meal.

18. The package according to claim 1, wherein the package resembles a child's building block and is configured to aid in providing a balanced meal to a toddler.

19. The package according to claim 1, wherein the body further defining a hook at a top portion of the package for receiving a hanger.

20. The package according to claim 1, wherein the consumable products are selected from the group consisting of snack foods, side meals, full meals, and combinations thereof.

21. The package according to claim 1, wherein the first projection of the package is configured to mate with a second projection of a second package.

22. The package according to claim 1, wherein the body having a first compartment and a second compartment connected by a perforation, wherein the first and second compartments are arranged side by side in a first configuration, and wherein the package is folded along the perforation such that the first compartment rests on top of the second compartment in a second configuration.

23. The package according to claim 22, further comprising a cover sealed to a top side of the package to seal the first and second compartments.

24. (canceled)

25. (canceled)

26. (canceled)

27. (canceled)
